(19) United States
(12) Patent Application Publication
(10) Pub. No.: US 2004/0101753 A1
(43) Pub. Date: May 27, 2004

(54) Positive electrode for lithium-sulfur battery and lithium-sulfur battery comprising same

(76) Inventor: Duck-Chul Hwang, Suwon-city (KR)

Correspondence Address: CHRISTIE, PARKER & HALE, LLP, 350 WEST COLORADO BOULEVARD, SUITE 500, PASADENA, CA, 91105, US

(21) Appl. No.: 10/719,614

(22) Filed: Nov. 21, 2003

(30) Foreign Application Priority Data
Nov. 26, 2002 (KR) 2002-0073961
Jan. 21, 2003 (KR) 2003-0003978

(51) Int. Cl. H01M 4/58; H01M 2/16; H01M 4/62

(52) U.S. Cl. 429/218.1; 429/217; 429/137; 429/231.95; 429/232

(57) ABSTRACT

Disclosed is a positive electrode for a lithium-sulfur battery including a positive active material selected from elemental sulfur (S₈), a sulfur-based compound and mixtures thereof; a conductive material; a binder; and an inorganic additive with a particle size D (v, 50%) of 5,000 nm or less and having insolubility to an electrolyte.

### CROSS REFERENCE TO RELATED APPLICATION

This application claims priority to application Nos. 2002-73961 and 2003-3978 filed in the Korean Intellectual Property Office on Nov. 26, 2002 and Jan. 21, 2003, the disclosures of which are incorporated hereinto by reference.

### FIELD OF THE INVENTION

The present invention relates to a positive electrode for a lithium-sulfur battery and a lithium-sulfur battery comprising the same, and more particularly, to a positive electrode for a lithium-sulfur battery exhibiting good cycle life characteristics.

### BACKGROUND OF THE INVENTION

The continued development of portable electronic devices has led to a corresponding increase in the demand for secondary batteries having both a lighter weight and a higher capacity. To satisfy these demands, the most promising approach is a lithium-sulfur battery with a positive electrode made of sulfur-based compounds.

Lithium-sulfur batteries use sulfur-based compounds with sulfur-sulfur bonds as a positive active material, and a lithium metal or a carbon-based compound as a negative active material. The carbon-based compound is one that can reversibly intercalate or deintercalate metal ions, such as lithium ions. Upon discharging (i.e., electrochemical reduction), the sulfur-sulfur bonds are cleaved, resulting in a decrease in the oxidation number of sulfur (S). Upon recharging (i.e., electrochemical oxidation), the sulfur-sulfur bonds are re-formed, resulting in an increase in the oxidation number of the S. The electrical energy is stored in the battery as chemical energy during charging, and is converted back to electrical energy during discharging.

With respect to specific density, the lithium-sulfur battery is the most attractive among the currently developing batteries since lithium has a specific capacity of 3,830 mAh/g, and sulfur has a specific capacity of 1,675 mAh/g. Further, the sulfur-based compounds are less costly than other materials, and they are environmentally friendly.

However, employing a positive electrode based on elemental sulfur in an alkali metal-sulfur battery system has been considered problematic. Although theoretically the reduction of sulfur to an alkali metal-sulfide confers a large specific energy, sulfur is known to be an excellent insulator, and problems using it for an electrode have been noted. Such problems include a very low percentage of utilization and low cycle life characteristics as a result of the sulfur and lithium sulfide (Li₂S) dissolving and diffusing from the positive electrode.

Thus, there have been various studies to improve the electrochemical redox reaction and to increase capacity.

### SUMMARY OF THE INVENTION

The present invention provides a positive electrode for a lithium-sulfur battery exhibiting good cycle life characteristic by controlling the roughness of the surface of the positive electrode using an additive with a critical particle size.

In one embodiment, the invention is directed to a positive electrode for a lithium-sulfur battery including a positive active material selected from elemental sulfur (S₈), a sulfur-based compound, or a mixture thereof; a conductive material; a binder; and an inorganic additive that is soluble in an electrolyte. The inorganic additive may be a metal oxide, a metal sulfide, or a mixture thereof. The particle size can be suitably controlled depending on the type of metal in the inorganic additive. If the metal is V, Zr, Al, or Ti, the particle size D (v, 50%) is preferably 5,000 nm or less.

The present invention also provides a lithium-sulfur battery including the positive electrode, a negative electrode and an electrolyte. The negative electrode includes a negative active material selected from a material that is capable of reversibly intercalating or deintercalating lithium ions, a material that reacts with lithium ions to prepare a lithium-included compound, a lithium metal, and a lithium alloy.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, wherein:

FIG. 1 is a drawing illustrating immersion of a positive electrode for a test;

FIG. 2 is an SEM photograph of an electrode obtained from a lithium-sulfur cell according to Example 1 of the present invention after 10 charge and discharge cycles;

FIG. 3 is a drawing illustrating a collected portion of a sample of the electrode used for measuring the particle size of an additive; and

FIG. 4 is a drawing illustrating a lithium-sulfur battery of the present invention.

### DETAILED DESCRIPTION OF THE INVENTION

Reference will now be made in detail to the present preferred embodiments of the present invention, examples of which are illustrated in the accompanying drawings, wherein like reference numerals refer to like elements throughout. The embodiments are described below in order to explain the present invention while referring to the figures.

The present invention relates to a positive electrode for a lithium-sulfur battery using an inorganic additive with a desired particle size, and that is insoluble in an electrolyte. The positive electrode can provide batteries exhibiting good cycle life characteristics.

Such an inorganic additive includes metal oxides, metal sulfides or a mixture thereof. Exemplary metals include V, Al, Zr, and Ti. Preferred are V₂O₅, Al₂O₃, ZrO₂, and TiS₂.

The preferred particle size of the inorganic additive depends on the type of metal, that is, the type of inorganic additive. If a V₂O₅, Al₂O₃, ZrO₂, or TiS₂ additive is used, the particle size D (v, 50%) is preferably 5,000 nm or less, more preferably from 1 to 5,000 nm, even more preferably from 5 to 4,000 nm, and still more preferably from 10 to 3,000 nm. In this application, the term “particle size D (v, 50%)” means a particle size in which particles distributed with various size such as 0.1, 0.2, 0.3 . . . 3, 5, 7, . . . 10, 20, or 30 μm are accumulated to 50 volume %. As the particle size D (v, 50%) decreases, ionic conductivity increases so that a small particle size is preferable. If the particle size D (v, 50%) is out of the range, the surface roughness (Ra) of a produced positive electrode increases, making the surface of the positive electrode uneven, thereby deteriorating the capacity and particularly cycle life characteristics.

The particle size of the inorganic additive may be controlled by a general mechanically mixing process such as a ball-milling process. The metal oxide or metal sulfide is pulverized in a solvent with a zirconia ball for 3 to 24 hours. If the pulverizing step is performed for less than 3 hours, desired particle sizes cannot be obtained. The particle size obtained from the pulverizing step for 24 hours is substantially the minimum size, so it is not required to perform the pulverizing step beyond this time. The solvent is any solvent that does not react with the metal oxide or metal sulfide, and useful solvents include isopropyl alcohol, ethyl alcohol, and methyl alcohol.

The additive with the above particle size renders a decrease in the average surface roughness Ra of 5 μm. Such a decreased surface roughness allows a decrease in interfacial resistance between a positive electrode and a separator, thereby decreasing internal resistance of batteries and providing good battery performance.

The present invention improves battery performance by controlling particle size of the inorganic additive. Studies on the specific effect of particle size on the battery performances have not been undertaken. For example, U.S. Pat. Nos. 6,238,821 and 6,210,831 disclose the use of a V₂O₅ additive in a positive electrode, and U.S. Pat. Nos. 6,238,821, 6,406,814 and 6,210,831 disclose the use of Al₂O₃ in a positive electrode. However, these patents are silent on control of the particle size of V₂O₅ and Al₂O₃. In addition, U.S. Pat. No. 6,130,007 discloses a vanadium oxide positive active material with a particle size of 1000 nm or less, but this did not exhibit suitable capacity and cycle life. U.S. Pat. No. 5,474,858 discloses a positive electrode with an alumina drying agent, but is silent on the particle size of alumina. U.S. Pat. No. 5,360,686 discloses alumina with a particle size of 0.5 micrometer. This patent uses alumina in order to increase the mechanical strength of an electrolyte, but it is silent regarding alumina with a suitable particle size being capable of decreasing internal resistance of the battery. Thus, it is well understood to one in the related art that the battery performance improvement effect of the present invention by using an additive with a critical particle size cannot be obtained from these cited references.

The positive electrode of the present invention includes the additive as well as a positive active material, a conductive material, and a binder.

The positive active material includes elemental sulfur (S₈), a sulfur-based compound, or a mixture thereof. The sulfur-based compound may be selected from Li₂Sₙ(n≧1), organic-sulfur compounds, and carbon-sulfur polymers ((C₂Sₓ)ₙ: x=2.5 to 50, n≧2).

The conductive material includes an electrically conductive material that facilitates the movement of electrons within the positive electrode. Examples of the conductive material include, but are not limited to, conductive materials such as graphite- and carbon-based materials, and conductive polymers. The graphite-based materials include KS 6 (manufactured by TIMCAL COMPANY), and the carbon-based materials include SUPER P (manufactured by MMM COMPANY), ketjen black, denka black, acetylene black, carbon black, and the like. Examples of the conductive polymer include, but are not limited to, polyaniline, polythiophene, polyacetylene, polypyrrole, and the like. The conductive material may be used alone or as a mixture of two or more of the above conductive materials.

A binder may be added to adhere the positive active material on a current collector. The binder may be poly(vinyl acetate), polyvinyl alcohol, polyethylene oxide, polyvinyl pyrrolidone, alkylated polyethylene oxide, crosslinked polyethylene oxide, polyvinyl ether, poly(methyl methacrylate), polyvinylidene fluoride, a copolymer of polyhexafluoropropylene and polyvinylidene fluoride (Trademark: KYNAR), polyethyl acrylate, polytetrafluoroethylene, polyvinyl chloride, polyacrylonitrile, polyvinyl pyridine, polystyrene, a derivative thereof, a blend thereof, or a copolymer thereof.

The positive electrode may further include a coating layer including a polymer, an inorganic material, or a mixture thereof.

The polymer may include polyvinylidene fluoride, a copolymer of polyvinylidene fluoride and hexafluoropropylene, poly(vinyl acetate), poly(vinyl butyral-co-vinyl alcohol-co-vinyl acetate), poly(methylmethacrylate-co-ethyl acrylate), polyacrylonitrile, polyvinyl chloride-co-vinyl acetate, polyvinyl alcohol, poly(1-vinylpyrrolidone-co-vinyl acetate), cellulose acetate, polyvinyl pyrrolidone, polyacrylate, polymethacrylate, polyolefin, polyurethane, polyvinyl ether, acrylonitrile-butadiene rubber, styrene-butadiene rubber, acrylonitrile-butadiene styrene, a sulfonated styrene/ethylene-butylene/styrene triblock copolymer, polyethylene oxide, or a mixture thereof.

Examples of inorganic material include colloidal silica, amorphous silica, surface-treated silica, colloidal alumina, amorphous alumina, tin oxide, titanium oxide, titanium sulfide (TiS₂), vanadium oxide, zirconium oxide (ZrO₂), iron oxide, iron sulfide (FeS), iron titanate (FeTiO₃), barium titanate (BaTiO₃), and mixtures thereof. The organic material may be conductive carbon.

The positive electrode of the present invention is produced by the general procedure in which the positive active material, the conductive material, the binder, and the inventive inorganic additive are mixed in a solvent to prepare a composition (e.g. in the form of slurry), and the composition is coated on a current collector.

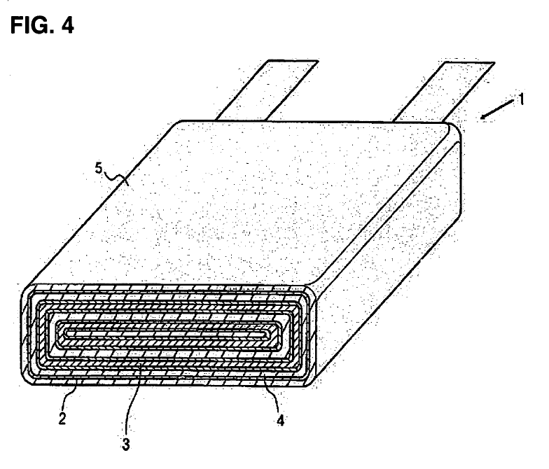

A lithium-sulfur battery of the present invention with the positive electrode includes a negative electrode and an electrolyte. An embodiment of a lithium-sulfur battery 1 of the present invention is shown in FIG. 4. The lithium-sulfur battery 1 in FIG. 4 includes the positive electrode 3, a negative electrode 4, and a separator 2 interposed between the positive electrode 3 and the negative electrode 4. The positive electrode 3, the negative electrode 4, and the separator 2 are received in a battery case 5. The electrolyte is present between the positive electrode 3 and the negative electrode 4.

The negative electrode of the lithium-sulfur battery includes a negative active material selected from materials in which lithium intercalation reversibly occurs, materials that react with lithium ions to form a lithium-containing compound, lithium metals, and lithium alloys.

The materials in which lithium intercalation reversibly occurs include carbon-based compounds. Any carbon-based compound may be used as long as it is capable of intercalating and deintercalating lithium ions. Examples of such carbon materials include crystalline carbon, amorphous carbon, and mixtures thereof.

Examples of the material that reacts with lithium ions to form a lithium-containing compound include, but are not limited to, tin oxide (SnO₂), titanium nitrate, and Si. The lithium alloys include alloys of lithium and a metal selected from Na, K, Rb, Cs, Fr, Be, Mg, Ca, Sr, Ba, Ra, Al, and Sn.

The negative electrode may include an inorganic protective layer, an organic protective layer, or a mixture thereof, on a surface of lithium metal. The inorganic protective layer includes Mg, Al, B, Sn, Pb, Cd, Si, In, Ga, lithium silicate, lithium borate, lithium phosphate, lithium phosphoronitride, lithium silicosulfide, lithium borosulfide, lithium aluminosulfide, or lithium phosphosulfide. The organic protective layer includes a conductive monomer, oligomer, or polymer selected from poly(p-phenylene), polyacetylene, poly(p-phenylene vinylene), polyaniline, polypyrrole, polythiophene, poly(2,5-ethylene vinylene), acetylene, poly(perinaphthalene), polyacene, and poly(naphthalene-2,6-di-yl).

In addition, during charging and discharging of the lithium-sulfur battery, the positive active material (active sulfur) converts to an inactive material (inactive sulfur), which can be attached to the surface of the negative electrode. The term “inactive sulfur”, as used herein, refers to sulfur that has no activity upon repeated electrochemical and chemical reactions so it cannot participate in an electrochemical reaction of the positive electrode. The inactive sulfur on the surface of the negative electrode acts as a protective layer of the lithium negative electrode. Accordingly, inactive sulfur, for example lithium sulfide, on the surface of the negative electrode can be used in the negative electrode.

The electrolyte includes an electrolytic salt and an organic solvent.

The organic solvent may be a sole solvent or a mixed organic solvent with at least two components. The mixed organic solvent includes at least two groups selected from weak polar solvent groups, strong polar solvent groups, and lithium protection groups.

The term “weak polar solvent”, as used herein, is defined as a solvent that is capable of dissolving elemental sulfur and has a dielectric coefficient of less than 15. The weak polar solvent is selected from aryl compounds, bicyclic ether, and acyclic carbonate compounds. The term “strong polar solvent”, as used herein, is defined as a solvent that is capable of dissolving lithium polysulfide and has a dielectric coefficient of more than 15. The strong polar solvent is selected from bicyclic carbonate compounds, sulfoxide compounds, lactone compounds, ketone compounds, ester compounds, sulfate compounds, and sulfite compounds. The term “lithium protection solvent”, as used herein, is defined as a solvent that forms a good protective layer, i.e. a stable solid-electrolyte interface (SEI) layer, on a lithium surface, and which shows a cyclic efficiency of at least 50%. The lithium protection solvent is selected from saturated ether compounds, unsaturated ether compounds, and heterocyclic compounds including N, O, and/or S.

Examples of the weak polar solvents include xylene, dimethoxyethane, 2-methyltetrahydrofuran, diethyl carbonate, dimethyl carbonate, toluene, dimethyl ether, diethyl ether, diglym, and tetraglyme. 0

Examples of the strong polar solvents include hexamethyl phosphoric triamide, [symbol] -butyrolactone, acetonitrile, ethylene carbonate, propylene carbonate, N-methylpyrrolidone, 3-methyl-2-oxazolidone, dimethyl formamide, sulfolane, dimethyl acetamide, dimethyl sulfoxide, dimethyl sulfate, ethylene glycol diacetate, dimethyl sulfite, and ethylene glycol sulfite.

Examples of the lithium protection solvents include tetrahydrofuran, 1,3-dioxolane, 3,5-dimethylisoxazole, 2,5-dimethyl furan, furan, 2-methyl furan, 1,4-oxane, and 4-methyldioxolane.

Examples of electrolyte salts include lithium trifluoromethane sulfonimide, lithium triflate, lithium perchlorate, LiPF₆, LiBF₄, tetraalkylammonium salts, such as tetrabutylammonium tetrafluoroborate (TBABF₄), liquid state salts at room temperature, e.g. imidazolium salts such as 1-ethyl-3-methylimidazolium Bis-(perfluoroethyl sulfonyl) imide (EMIBeti), and combinations thereof.

The following examples illustrate the present invention in further detail, but it is understood that the present invention is not limited by these examples.

### EXAMPLE 1

V₂O₅ powder was pulverized in an isopropyl alcohol solvent with a zirconia ball for 3 hours, and the resulting material was dried at 80° C. to prepare a V₂O₅ additive with a particle size D (v, 50%) of 5,000 nm.

The V₂O₅ additive, an elemental sulfur (S₈) positive active material, a carbon conductive material, and a polyethyleneoxide binder were mixed in an acetonitrile solvent in the weight ratio of 1:6:2:2 with a ball to prepare a positive active material slurry. The elemental sulfur (S₈) was obtained from pulverization with a zirconia ball in an isopropylalcohol solvent and drying, and it had a particle size D (v, 50%) of 5,000 nm.

The positive active material slurry was coated on a carbon-coated Al current collector to produce a positive electrode for a lithium-sulfur battery.

### EXAMPLE 2

A positive electrode was produced by the same procedure as in Example 1, except that the pulverization step was performed for 6 hours to prepare a V₂O₅ additive with a particle size D (v, 50%) of 200 nm.

### EXAMPLE 3

A positive electrode was produced by the same procedure as in Example 1, except that the pulverization step was performed for 12 hours to prepare a V₂O₅ additive with a particle size D (v, 50%) of 50 nm.

### Example 4

A positive electrode was produced by the same procedure as in Example 1, except that the pulverization step was performed for 24 hours to prepare a V205 additive with a particle size D (v, 50%) of 10 nm.

### EXAMPLE 5

A positive electrode was produced by the same procedure as in Example 1, except that the pulverization step was performed for 1 hour to prepare a V₂O₅ additive with a particle size D (v, 50%) of 30,000 nm.

### EXAMPLE 6

A positive electrode was produced by the same procedure as in Example 1, except that the V₂O₅ additive with a particle size D (v, 50%) of 150,000 nm without a pulverization step was used.

### COMPARATIVE EXAMPLE 1

A positive electrode was produced by the same procedure as in Example 1, except that a V₂O₅ additive was not used.

<Experiment 1: Measurement of ionic conductivity according to a particle size D (v, 50%) of V₂O₅>

Polyethylene oxide with a molecular weight of 5,000,000 was dissolved in acetonitrile, and a LiN(SO₂CF₃)₂ lithium salt was added thereto and dissolved therein until the mole ratio of ethylene oxide to Li reached 10:1. The V₂O₅ additive according to Examples 1 to 7 was added to the resulting solution in an amount of 10 wt % based on the total amount of polyethylene oxide and the LiN(SO₂CF₃)₂ lithium salt, and they were shaken for 2 hours. The resulting solution was cast to form a polymer film, and the ionic conductivity thereof was measured. The results are presented in Table 1.

TABLE 1

| | Ionic |
|---|---|
| | conductivity |
| | (S/cm) |
| | (room |
| Type of polymer film | temperature) |
| PEO₁₀—LiN(SO₂CF₃)₂ | 9.6 × 10⁻⁷ |
| PEO₁₀—LiN(SO₂CF₃)₂—V₂O₅(D(v, 50%) = 150,000 nm) | 1.0 × 10⁻⁶ |
| PEO₁₀—LiN(SO₂CF₃)₂—V₂O₅(D(v, 50%) = 30,000 nm) | 2.5 × 10⁻⁶ |
| PEO₁₀—LiN(SO₂CF₃)₂—V₂O₅(D(v, 50%) = 5,000 nm) | 4.5 × 10⁻⁶ |
| PEO₁₀—LiN(SO₂CF₃)₂—V₂O₅(D(v, 50%) = 200 nm) | 8.6 × 10⁻⁶ |
| PEO₁₀—LiN(SO₂CF₃)₂—V₂O₅(D(v, 50%) = 50 nm) | 3.0 × 10⁻⁵ |
| PEO₁₀—LiN(SO₂CF₃)₂—V₂O₅(D(v, 50%) = 10 nm) | 5.0 × 10⁻⁵ |

As shown in Table 1, the addition of V₂O₅ increased ionic conductivity, and such an increase in ionic conductivity is improved as the particle size of V₂O₅ decreases. This believed to be because the inorganic additive such as V₂O₅ prevents crystallization of the polymer.

Increases in ionic conductivity according to the amount of V₂O₅ were measured. The V₂O₅ with a particle size D (v, 50%) of 10 nm was used. The results are presented in Table 2.

TABLE 2

| | Ionic conductivity |
|---|---|
| Type of polymer film | (S/cm) (room temperature) |
| PEO₁₀—LiN(SO₂CF₃)₂—V₂O₅(2 wt %) | 1.0 × 10⁻⁵ |
| PEO₁₀—LiN(SO₂CF₃)₂—V₂O₅(5 wt %) | 4.0 × 10⁻⁵ |
| PEO₁₀—LiN(SO₂CF₃)₂—V₂O₅(10 wt %) | 5.0 × 10⁻⁵ |
| PEO₁₀—LiN(SO₂CF₃)₂—V₂O₅(15 wt %) | 3.5 × 10⁻⁵ |
| PEO₁₀—LiN(SO₂CF₃)₂—V₂O₅(20 wt %) | 2.0 × 10⁻⁵ |
| PEO₁₀—LiN(SO₂CF₃)₂—V₂O₅(25 wt %) | 8.0 × 10⁻⁶ |

It is evident from Table 2 that the amount of 5 to 15 wt % of V₂O₅ exhibited higher ionic conductivity.

These two test results indicate that V₂O₅ increases ionic conductivity, and as the particle size of V₂O₅ decreases, ionic conductivity increases.

<Experiment 2: Measurement of Surface Roughness>

The surface roughness Ra of the positive electrodes according to Examples 1 to 6 and Comparative Example 1 were measured, and the results are shown in Table 3.

TABLE 3

| | | Surface |
|---|---|---|
| | Composition of the | roughness |
| | positive electrode (weight ratio) | (Ra) |
| Comparative | Sulfur/Conductive material/Binder (6/2/2) | 3.0 |
| Example 1 | | |
| Example 6 | Sulfur/Conductive material/Binder/ | 12.6 |
| | V₂O₅(A:D(v, 50%) = 150,000 nm) (6/2/2/1) | |
| Example 5 | Sulfur/Conductive material/Binder/ | 6.6 |
| | V₂O₅(A:D(v, 50%) = 30,000 nm) (6/2/2/1) | |
| Example 1 | Sulfur/Conductive material/Binder/ | 3.0 |
| | V₂O₅(A:D(v, 50%) = 5,000 nm) (6/2/2/1) | |
| Example 2 | Sulfur/Conductive material/Binder/ | 2.9 |
| | V₂O₅(A:D(v, 50%) = 200 nm) (6/2/2/1) | |
| Example 3 | Sulfur/Conductive material/Binder/ | 2.8 |
| | V₂O₅(A:D(v, 50%) = 50 nm) (6/2/2/1) | |
| Example 4 | Sulfur/Conductive material/Binder/ | 2.5 |
| | V₂O₅(A:D(v, 50%) = 10 nm) (6/2/2/1) | |

In Table 3, Ra indicates the arithmetic mean of each peak (between highest and lowest peaks), and the lower Ra indicates a more uniform surface. It is evident from Table 3 that Examples 5 and 6 with the particle size of V₂O₅ larger than the sulfur active material (5,000 nm) exhibited poorer uniformity (unevenness and roughness) than Comparative Example 1 without V₂O₅, and Examples 1 to 4 with a smaller or the same particle size of V₂O₅ as the active material exhibited substantially the same or better uniformity.

<Experiment 3: SEM>Measurement

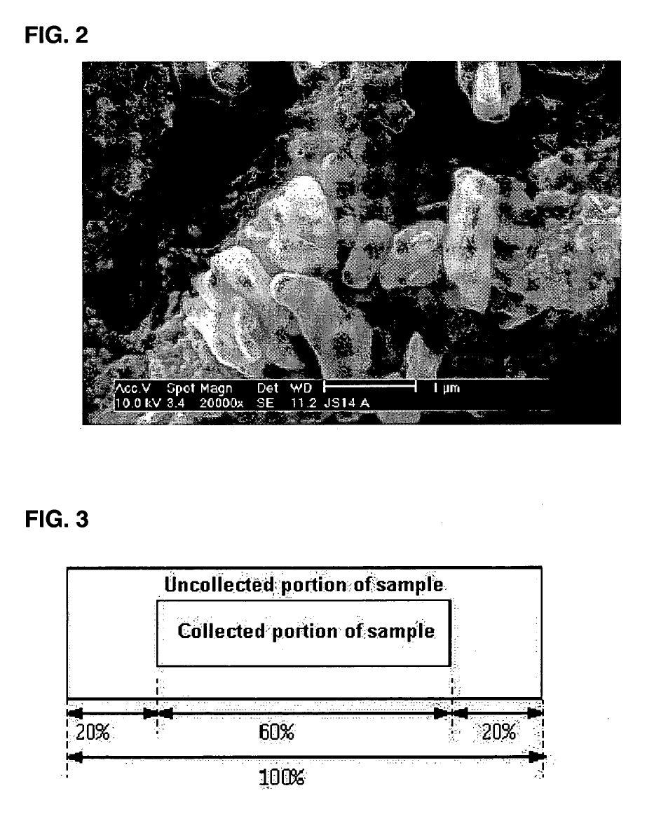

The lithium-sulfur cell using the positive electrode according to Example 1 was charged and discharged 10 times, and the cell was separated. Thereafter, a central portion from the positive electrode was sampled by the following procedure, and a SEM photograph of the central portion is shown in FIG. 2. The central portion was a portion corresponding to 60% thereof, with the exception of right and left 20% portions, when the total longitudinal direction length of the positive electrode is seen as 100%, as shown in FIG. 3. In addition, the central portion did not include the folded portion where the electrode was wound. The central portion was controlled to have a horizontal length of 1 to 5 cm, and a vertical length of 1 to 5 cm.

The central portion of the electrode was washed with a dimethoxyethane solvent for 10 seconds and then dried at 40° C. for 24 hours.

In FIG. 2, the V₂O₅ additive appeared in the form of oval particles rather than having a spherical shape. In this case, the particle size of the additive is determined as the longest cross-section of the oval, and is 5,000 nm or less. In the figure, most particles have a diameter of 1,000 nm or less. This is believed to be because of the use of the ball in the slurry preparation. If the ball is not used in the slurry preparation, it is expected that the particle size of the additive will be maintained.

<Experiment 4: Measurement of Battery Performance>

Using positive electrodes according to each of Examples 1 to 6 and Comparative Example 1, pouch-type lithium-sulfur cells were fabricated by the following procedure. The size of each positive electrode was 25 mm×50 mm. The cells were test cells with a higher capacity than a coin cell (capacity of 3-5 mAh).

A tab was welded to each positive electrode and the resulting positive electrode was placed in a pouch. On the positive electrode, a separator was positioned. A tab-attached lithium foil was placed on the separator, and the pouch was sealed except for at an electrolyte inserting hole. 1M LiN(SO₂CF₃)₂ in dimethoxyethane/1,3-dioxolane (80/20 volume ratio) was injected into the pouch.

The cell was charged at 0.2C and discharged at 0.5C, the 1^{st} capacity and cycle life for 100^{th} cycles were measured, and the results are presented in Table 4. In addition, internal resistance of the battery and surface roughness Ra of the positive electrode are shown in Table 4.

TABLE 4

| | | | | Cycle life |
|---|---|---|---|---|
| | Surface | Internal | 1^{st} capacity | for 100th |
| | roughness (Ra) | resistance (Ω) | (mAh/g) | cycles (%) |
| Comparative | 3.0 | 9.8 | 1200 | 60 |
| Example 1 | | | | |
| Example 6 | 12.6 | 15.3 | 1053 | 55 |
| Example 5 | 6.6 | 12.6 | 1125 | 58 |
| Example 1 | 3.0 | 9.8 | 1215 | 76 |
| Example 2 | 2.9 | 9.5 | 1230 | 85 |
| Example 3 | 2.8 | 9.6 | 1250 | 88 |
| Example 4 | 2.5 | 9.5 | 1280 | 90 |

It is shown in Table 4 that Examples 1 to 4 using V₂O₅ with the same or smaller particle size than the sulfur positive active material (5,000 nm) exhibited lower surface roughness than Comparative Example 1 without V₂O₅. Such a lower surface roughness renders a decrease in interfacial resistance, causing a decrease in internal resistance of the battery and an increase in 1^{st} capacity and cycle life.

On the other hand, Examples 5 and 6 using V₂O₅ with a particle size larger than the sulfur positive active material (5,000 nm) exhibited greater surface roughness, which results in an increase in internal resistance and a decrease in capacity and cycle life.

### EXAMPLES 7 to 11

### Test for Battery Performance According to Amount of Added V₂O₅

Positive electrodes were produced by the same procedure as in Example 1, except that amounts of V₂O₅ with a particle size D (v, 50%) of 10 nm were changed as set forth in the following Table 5. The surface roughness of each positive electrode was measured, and the results are shown in Table 5. The result according to Example 4 with a particle size D (v, 50%) of 10 nm is also shown in Table 5.

TABLE 5

| | | Surface |
|---|---|---|
| | Composition of positive | roughness |
| | electrode (weight ratio) | (Ra) |
| Comparative | Sulfur/Conductive material/Binder (60/20/20) | 3.0 |
| Example 1 | | |
| Example 7 | Sulfur/Conductive material/Binder/ | 2.9 |
| | V₂O₅(A:D(v, 50%) = 10 nm) (60/20/20/2) | |
| Example 8 | Sulfur/Conductive material/Binder/ | 2.8 |
| | V₂O₅(A:D(v, 50%) = 10 nm) (60/20/20/5) | |
| Example 4 | Sulfur/Conductive material/Binder/ | 2.5 |
| | V₂O₅(A:D(v, 50%) = 10 nm) (60/20/20/10) | |
| Example 9 | Sulfur/Conductive material/Binder/ | 2.4 |
| | V₂O₅(A:D(v, 50%) = 10 nm) (60/20/20/15) | |
| Example 10 | Sulfur/Conductive material/Binder/ | 2.6 |
| | V₂O₅(A:D(v, 50%) = 10 nm) (60/20/20/20) | |
| Example 11 | Sulfur/Conductive material/Binder/ | 2.5 |
| | V₂O₅(A:D(v, 50%) = 10 nm) (60/20/20/25) | |

Table 4 indicates that the same or smaller particle size of V₂O₅ than the positive active material decreases surface roughness when compared with Comparative Example 1 without V₂O₅.

<Experiment 5: Measurement of Battery Performance>

Using positive electrodes according to each of Examples 4 and 7 to 11, pouch-type lithium sulfur cells were fabricated by the same procedure as in Experiment 4. The cells were charged at 0.2C and discharged at 0.5C, the 1^{st} capacity and cycle life for the 100^{th} cycles were measured, and the results are presented in Table 6. In addition, internal resistance of each battery and surface roughness Ra of each positive electrode are shown in Table 6.

TABLE 6

| | | | | Cycle life |
|---|---|---|---|---|
| | Surface | Internal | 1^{st} capacity | for 100^{th} |
| | roughness (Ra) | resistance (Ω) | (mAh/g) | cycles (%) |
| Comparative | 3.0 | 9.8 | 1200 | 60 |
| Example 1 | | | | |
| Example 7 | 2.9 | 9.7 | 1220 | 70 |
| Example 8 | 2.8 | 9.5 | 1245 | 88 |
| Example 4 | 2.5 | 9.5 | 1280 | 90 |
| Example 9 | 2.4 | 9.3 | 1254 | 84 |
| Example 10 | 2.6 | 9.4 | 1234 | 82 |
| Example 11 | 2.5 | 9.3 | 1230 | 72 |

It is shown in Table 6 that Examples 4 and 7 to 11 using V₂O₅ with the same or smaller particle size than the sulfur positive active material (5,000 nm) exhibited lower surface roughness than Comparative Example 1 without V₂O₅. Such a lower surface roughness renders a decrease in interfacial resistance, causing a decrease in internal resistance of the battery. As a result, the 1^{st} capacities in Examples 4 and 7 to 11 are slightly larger than that in Comparative Example 1, and the cycle life greatly increased by 5 to 20% when compared with Comparative Example 1. This is believed to result from higher ionic conductivity in 5 to 20 wt % of V₂O₅, even though Examples 4 and 7 to 11 have similar surface roughness (See Table 2).

As a result, the V₂O₅ additive with the critical particle size increases ionic conductivity of the positive electrode and decreases surface roughness, thereby increasing capacity from 1200 mAh to 1280 mAh, and improving cycle life from 60% to 90%.

Experiment 6: Immersion of Positive Electrode in Electrolyte

84 wt % of elemental sulfur (S₈), 12 wt % of a carbon conductive material, and 4 wt % of a styrene butadiene rubber binder were mixed, and V₂O₅ was added to the mixture in a water solvent to prepare positive active material slurries. The amounts of V₂O₅ were 2, 5, 10, 15, 20, 25, and 30 parts by weight based on 100 parts by weight of the mixture.

The slurries were coated on carbon-coated Al current collectors. The coated collectors were dried at room temperature for 2 hours, then dried at 80° C. for 12 hours to produce positive electrodes.

The positive electrodes were cut with a width of 2.5 cm and a length of 5.0 cm.

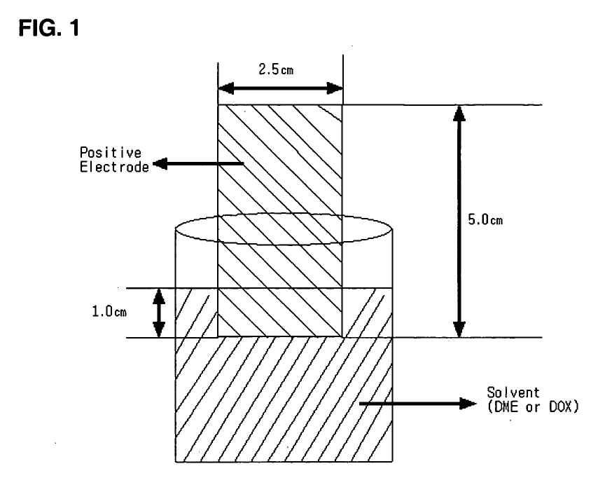

As shown in FIG. 1, 90 ml of dimethylethane and dioxolane electrolytic solvents were respectively poured into 100 ml beakers, and 1 cm ends of the cut positive electrodes were immersed in the electrolytic solvents in the beakers for 1 minute. The height, which indicates a degree to which the solvent is absorbed into the electrode and wicks up the electrode, was measured at room temperature under a normal atmosphere. The results are shown in Table 7.

TABLE 7

| | Immersed | Immersed |
|---|---|---|
| | height of | height of |
| | dimethoxyethane | dioxolane |
| | (mm) | (mm) |
| Sulfur/Conductive material/Binder | 2.0 | 1.0 |
| (84/12/4) | | |
| Sulfur/Conductive material/Binder/ | 2.5 | 2.0 |
| V₂O₅ (84/12/4/2) | | |
| Sulfur/Conductive material/Binder/ | 4.0 | 3.0 |
| V₂O₅ (84/12/4/5) | | |
| Sulfur/Conductive material/Binder/ | 6.0 | 3.5 |
| V₂O₅ (84/12/4/10) | | |
| Sulfur/Conductive material/Binder/ | 8.0 | 6.0 |
| V₂O₅ (84/12/4/15) | | |
| Sulfur/Conductive material/Binder/ | 8.5 | 6.0 |
| V₂O₅ (84/12/4/20) | | |
| Sulfur/Conductive material/Binder/ | 8.5 | 6.0 |
| V₂O₅ (84/12/4/25) | | |
| Sulfur/Conductive material/Binder/ | 8.6 | 6.0 |
| V₂O₅ (84/12/4/30) | | |

The results from Table 7 are believed to come about because the porosity of the positive electrodes increases by the addition of V₂O₅, which results in better immersion of the electrolyte. It is believed that such a better immersion allows retention of electrolyte in the positive electrode during the charge and the discharge, and prevents damage to the negative electrode due to the electrolyte, thereby improving cycle life.

### EXAMPLE 12

A ZrO₂ additive with a particle size D (v, 50%) of 3,000 nm, an elemental sulfur (S₈) positive active material, a carbon conductive material, and a polyethyleneoxide binder were mixed in an acetonitrile solvent in the weight ratio of 1:6:2:2 with a ball to prepare a positive active material slurry. The elemental sulfur (S₈) was obtained from pulverization with a zirconia ball in an isopropylalcohol solvent and drying, and it had a particle size D (v, 50%) of 5,000 nm.

The positive active material slurry was coated on a carbon-coated Al current collector to produce a positive electrode for a lithium-sulfur battery.

### EXAMPLE 13

ZrO₂ powder was pulverized in an isopropyl alcohol solvent with a zirconia ball for 1 hour, and the resulting material was dried at 80° C. to prepare a ZrO₂ additive with a particle size D (v, 50%) of 2,000 nm.

The ZrO₂ additive, an elemental sulfur (S₈) positive active material, a carbon conductive material, and a polyethyleneoxide binder were mixed in an acetonitrile solvent in the weight ratio of 1:6:2:2 with a ball to prepare a positive active material slurry. The elemental sulfur (S₈) was obtained from pulverization with a zirconia ball in an isopropylalcohol solvent and drying, and it had a particle size D (v, 50%) of 5,000 nm.

The positive active material slurry was coated on a carbon-coated Al current collector to produce a positive electrode for a lithium-sulfur battery.

### EXAMPLE 14

A positive electrode was produced by the same procedure as in Example 13, except that the pulverization step was performed for 6 hours to prepare a ZrO₂ additive with a particle size D (v, 50%) of 1,000 nm.

### EXAMPLE 15

A positive electrode was produced by the same procedure as in Example 13, except that the pulverization step was performed for 12 hours to prepare a ZrO₂ additive with a particle size D (v, 50%) of 100 nm.

### EXAMPLE 16

A positive electrode was produced by the same procedure as in Example 13, except that the pulverization step was performed for 24 hours to prepare a ZrO₂ additive with a particle size D (v, 50%) of 10 nm.

<Experiment 7: Measurement of Ionic Conductivity According to a Particle Size D (v, 50%) of ZrO₂>

Polyethylene oxide with a molecular weight of 5,000,000 was dissolved in acetonitrile, and a LiN(SO₂CF₃)₂ lithium salt was added thereto and dissolved therein until the mole ratio of ethylene oxide to Li reached 10:1. The ZrO₂ additives according to Examples 10 to 14 were respectively added to the resulting solution in an amount of 10 wt % based on the total amount of polyethylene oxide and the LiN(SO₂CF₃)₂ lithium salt, and they were shaken for 2 hours. The resulting solutions were cast to form polymer films, and ionic conductivity thereof was measured. The results are presented in Table 8.

TABLE 8

| | Ionic |
|---|---|
| | conductivity |
| | (S/cm) |
| | (room |
| Type of polymer film | temperature) |
| PEO₁₀—LiN(SO₂CF₃)₂ | 9.6 × 10⁻⁷ |
| PEO₁₀—LiN(SO₂CF₃)₂—ZrO₂(D(v, 50%) = 3,000 nm) | 1.1 × 10⁻⁶ |
| PEO₁₀—LiN(SO₂CF₃)₂—ZrO₂(D(v, 50%) = 2,000 nm) | 2.7 × 10⁻⁶ |
| PEO₁₀—LiN(SO₂CF₃)₂—ZrO₂(D(v, 50%) = 1,000 nm) | 8.9 × 10⁻⁶ |
| PEO₁₀—LiN(SO₂CF₃)₂—ZrO₂(D(v, 50%) = 100 nm) | 3.5 × 10⁻⁶ |
| PEO₁₀—LiN(SO₂CF₃)₂—ZrO₂(D(v, 50%) = 10 nm) | 5.1 × 10⁻⁵ |

As shown in Table 8, the addition of ZrO₂ increases ionic conductivity, and such an increase in ionic conductivity is further improved as the particle size of ZrO₂ becomes smaller. This believed to come about because the inorganic additive such as ZrO₂ prevents crystallization of the polymer.

Increases in ionic conductivity according to the amount of ZrO₂ were measured. ZrO₂ with a particle size D (v, 50%) of 10 nm was used. The results are presented in Table 9.

TABLE 9

| | Ionic conductivity (S/cm) |
|---|---|
| Type of polymer film | (room temperature) |
| PEO₁₀—LiN(SO₂CF₃)₂—ZrO₂ (2 wt %) | 1.2 × 10⁻⁶ |
| PEO₁₀—LiN(SO₂CF₃)₂—ZrO₂ (5 wt %) | 4.2 × 10⁻⁶ |
| PEO₁₀—LiN(SO₂CF₃)₂—ZrO₂ (10 wt %) | 5.1 × 10⁻⁶ |
| PEO₁₀—LiN(SO₂CF₃)₂—ZrO₂ (15 wt %) | 3.3 × 10⁻⁶ |
| PEO₁₀—LiN(SO₂CF₃)₂—ZrO₂ (20 wt %) | 2.1 × 10⁻⁶ |
| PEO₁₀—LiN(SO₂CF₃)₂—ZrO₂ (25 wt %) | 8.9 × 10⁻⁶ |

It is evident from Table 9 that an amount of 5 to 15 wt % of ZrO₂ exhibited higher ionic conductivity.

These two test results indicate that ZrO₂ increases ionic conductivity and as the particle size of ZrO₂ decreases, ionic conductivity increases.

<Experiment 8: Measurement of Surface Roughness>

The surface roughness Ra of the positive electrodes according to Examples 12 to 16 and Comparative Example 1 were measured, and the results are shown in Table 10.

TABLE 10

| | | Surface |
|---|---|---|
| | Composition of the positive | roughness |
| | electrode (weight ratio) | (Ra) |
| Comparative | Sulfur/Conductive material/Binder (6/2/2) | 3.0 |
| Example 1 | | |
| Example 12 | Sulfur/Conductive material/Binder/ | 2.9 |
| | ZrO₂(A:D(v, 50%) = 150000 nm) (6/2/2/1) | |
| Example 13 | Sulfur/Conductive material/Binder/ | 2.6 |
| | ZrO₂(A:D(v, 50%) = 30000 nm) (6/2/2/1) | |
| Example 14 | Sulfur/Conductive material/Binder/ | 2.5 |
| | ZrO₂(A:D(v, 50%) = 5000 nm) (6/2/2/1) | |
| Example 15 | Sulfur/Conductive material/Binder/ | 2.4 |
| | ZrO₂(A:D(v, 50%) = 200 nm) (6/2/2/1) | |
| Example 16 | Sulfur/Conductive material/Binder/ | 2.3 |
| | ZrO₂(A:D(v, 50%) = 50 nm) (6/2/2/1) | |

In Table 10, Ra indicates the arithmetic mean of each peak (between highest and lowest peaks), and the lower Ra indicates a more uniform surface. It is evident from Table 10 that Comparative Example 1 without ZrO₂ exhibited poor uniformity (unevenness), whereas Examples 12 to 16 with ZrO₂ exhibited good uniformity.

<Experiment 9: Measurement of Battery Performance>

Using positive electrodes according to each of Examples 12 to 16 and Comparative Example 1, pouch-type lithium-sulfur cells were fabricated by the following procedure. The size of each positive electrode was 25 mm×50 mm. The cells were test cells with a higher capacity than a coin cell (capacity of 3-5 mAh).

A tab was welded to each positive electrode, and the resulting positive electrode was placed in a pouch. On the positive electrode, a separator was positioned. A tab-attached lithium foil was placed on the separator, and the pouch was sealed except for an electrolyte inserting hole. 1M LiN(SO₂CF₃)₂ in dimethoxyethane/1,3-dioxolane (80/20 volume ratio) was injected into the pouch.

Each cell was charged at 0.2C and discharged at 0.5C, and the 1^{st} capacity and cycle life for 100^{th} cycles were measured, and the results are presented in Table 11. In addition, internal resistance of each battery and surface roughness Ra of each positive electrode are shown in Table 11.

TABLE 11

| | | | | Cycle life |
|---|---|---|---|---|
| | Surface | Internal | 1^{st} capacity | for 100th |
| | roughness (Ra) | resistance (Ω) | (mAh/g) | cycles (%) |
| Comparative | 3.0 | 9.8 | 1200 | 60 |
| Example 1 | | | | |
| Example 12 | 2.9 | 9.8 | 1050 | 65 |
| Example 13 | 2.6 | 9.6 | 1122 | 70 |
| Example 14 | 2.5 | 9.5 | 1233 | 86 |
| Example 15 | 2.4 | 9.6 | 1252 | 87 |
| Example 16 | 2.3 | 9.5 | 1288 | 91 |

It is shown in Table 11 that Examples 12 to 16 using ZrO₂ exhibited lower surface roughness than Comparative Example 1 without ZrO₂. Such a lower surface roughness renders a decrease in interfacial resistance, causing a decrease in internal resistance of the battery and increases in 1^{st} capacity and cycle life.

### EXAMPLES 17 to 21

### Test for Battery Performance According to Amount of Added ZrO₂

Positive electrodes for a lithium-sulfur cell were produced by the same procedure as in Example 1, except that the amounts of ZrO₂ with a particle size D (v, 50%) of 10 nm were varied as set forth in the following Table 12. The surface roughness of each positive electrode was measured, and the results are shown in Table 12. The result according to Example 16 with a particle size D (v, 50%) of 10 nm is also shown in Table 12.

TABLE 12

| | Composition of positive | Surface |
|---|---|---|
| | electrode (weight ratio) | roughness (Ra) |
| Comparative | Sulfur/Conductive material/Binder | 3.0 |
| Example 1 | (60/20/20) | |
| Example 17 | Sulfur/Conductive material/Binder/ | 2.9 |
| | ZrO₂(A:D(v, 50%) = 10 nm) | |
| | (60/20/20/2) | |
| Example 18 | Sulfur/Conductive material/Binder/ | 2.8 |
| | ZrO₂(A:D(v, 50%) = 10 nm) | |
| | (60/20/20/5) | |
| Example 16 | Sulfur/Conductive material/Binder/ | 2.5 |
| | ZrO₂(A:D(v, 50%) = 10 nm) | |
| | (60/20/20/10) | |
| Example 19 | Sulfur/Conductive material/Binder | 2.4 |
| | /ZrO₂(A:D(v, 50%) = 10 nm) | |
| | (60/20/20/15) | |
| Example 20 | Sulfur/Conductive material/Binder/ | 2.6 |
| | ZrO₂(A:D(v, 50%) = 10 nm) | |
| | (60/20/20/20) | |
| Example 21 | Sulfur/Conductive material/Binder/ | 2.5 |
| | ZrO₂(A:D(v, 50%) = 10 nm) | |
| | (60/20/20/25) | |

Table 12 indicates that the same or smaller particle size of ZrO₂ than the positive active material decreases surface roughness when compared with Comparative Example 1 without ZrO₂.

<Experiment 10: Measurement of Battery Performance>

Using positive electrodes according to each of Examples 16 to 21, pouch-type lithium sulfur cells were fabricated by the same procedure as in Experiment 8. The cells were charged at 0.2C and discharged at 0.5C, and the 1^{st} capacity and cycle life for 100^{th} cycles were measured, and the results are presented in Table 13. In addition, internal resistance of each battery and surface roughness Ra of each positive electrode are shown in Table 13.

TABLE 13

| | | | | Cycle life |
|---|---|---|---|---|
| | Surface | Internal | 1^{st} capacity | for 100^{th} |
| | roughness (Ra) | resistance (Ω) | (mAh/g) | cycles (%) |
| Comparative | 3.0 | 9.8 | 1200 | 60 |
| Example 1 | | | | |
| Example 17 | 2.9 | 9.6 | 1225 | 71 |
| Example 18 | 2.7 | 9.5 | 1249 | 87 |
| Example 16 | 2.3 | 9.5 | 1288 | 91 |
| Example 19 | 2.4 | 9.4 | 1258 | 85 |
| Example 20 | 2.5 | 9.4 | 1233 | 81 |
| Example 21 | 2.5 | 9.3 | 1232 | 74 |

It is shown in Table 13 that Examples 16 to 21 using ZrO₂ exhibited lower surface roughness than Comparative Example 1 without ZrO₂. Such lower surface roughness renders a decrease in interfacial resistance between the positive electrode and the separator, causing a decrease in internal resistance of the battery. As a result, the 1^{st} capacities in Examples 16 to 21 are slightly larger than that in Comparative Example 1, and the cycle life greatly increased by 5 to 20% when compared with Comparative Example 1. This result is believed to come about from the higher ionic conductivity in 5 to 20 wt % of V₂O₅ even though Examples 16 to 21 have similar surface roughness (See Table 8).

As a result, the ZrO₂ additive with the critical particle size increases ionic conductivity of the positive electrode and decreases surface roughness, thereby increasing capacity from 1200 mAh to 1288 mAh, and improving cycle life from 60% to 91%.

### EXAMPLE 22

A TiS₂ additive with a particle size D (v, 50%) of 75,000 nm, an elemental sulfur (S₈) positive active material, a carbon conductive material and a polyethyleneoxide binder were mixed in an acetonitrile solvent in the weight ratio of 1:6:2:2 with a ball to prepare a positive active material slurry. The elemental sulfur (S₈) was obtained from pulverization with a zirconia ball in an isopropylalcohol solvent and drying, and it had a particle size D (v, 50%) of 5,000 nm.

The positive active material slurry was coated on a carbon-coated Al current collector to produce a positive electrode for a lithium-sulfur battery.

### EXAMPLE 23

TiS₂ powder was pulverized in an isopropyl alcohol solvent with a zirconia ball for 1 hour, and the resulting material was dried at 80° C. to prepare a TiS₂ additive with a particle size D (v, 50%) of 20,000 nm.

The TiS₂ additive, an elemental sulfur (S₈) positive active material, a carbon conductive material, and a polyethyleneoxide binder were mixed in an acetonitrile solvent in the weight ratio of 1:6:2:2 with a ball to prepare a positive active material slurry. The elemental sulfur (S₈) was obtained from pulverization with a zirconia ball in an isopropylalcohol solvent and drying, and it had a particle size D (v, 50%) of 5,000 nm.

The positive active material slurry was coated on a carbon-coated Al current collector to produce a positive electrode for a lithium-sulfur battery.

### EXAMPLE 24

A positive electrode was produced by the same procedure as in Example 23, except that the pulverization step was performed for 3 hours to prepare a TiS₂ additive with a particle size D (v, 50%) of 5,000 nm.

### EXAMPLE 25

A positive electrode was produced by the same procedure as in Example 23, except that the pulverization step was performed for 6 hours to prepare a TiS₂ additive with a particle size D (v, 50%) of 1,000 nm.

### EXAMPLE 26

A positive electrode was produced by the same procedure as in Example 23 except that a pulverization step was performed for 12 hours to prepare a TiS₂ additive with a particle size D (v, 50%) of 100 nm.

### EXAMPLE 27

A positive electrode was produced by the same procedure as in Example 23, except that the pulverization step was performed for 24 hours to prepare a TiS₂ additive with a particle size D (v, 50%) of 10 nm.

<Experiment 11: Measurement of Ionic Conductivity According to a Particle Size D (V, 50%) of TiS₂>

Polyethylene oxide with a molecular weight of 5,000,000 was dissolved in acetonitrile, and a LiN(SO₂CF₃)₂ lithium salt was added thereto and dissolved therein until the mole ratio of ethylene oxide to Li reached 10:1. The TiS₂ additives according to Examples 20 to 25 were added to the resulting solution in an amount of 10 wt % based on the total amount of polyethylene oxide and the LiN(SO₂CF₃)₂ lithium salt, and they were shaken for 2 hours. The resulting solutions were cast to form polymer films, and the ionic conductivity of each was measured. The results are presented in Table 14.

TABLE 14

| | Ionic |
|---|---|
| | conductivity |
| | (S/cm) |
| | (room |
| Type of polymer film | temperature) |
| PEO₁₀—LiN(SO₂CF₃)₂ | 9.6 × 10⁻⁷ |
| PEO₁₀—LiN(SO₂CF₃)₂—TiS₂(D(v, 50%) = 75,000 nm) | 1.1 × 10⁻⁶ |
| PEO₁₀—LiN(SO₂CF₃)₂—TiS₂(D(v, 50%) = 20,000 nm) | 2.7 × 10⁻⁶ |
| PEO₁₀—LiN(SO₂CF₃)₂—TiS₂(D(v, 50%) = 5,000 nm) | 5.0 × 10⁻⁶ |
| PEO₁₀—LiN(SO₂CF₃)₂—TiS₂(D(v, 50%) = 1,000 nm) | 8.9 × 10⁻⁶ |
| PEO₁₀—LiN(SO₂CF₃)₂—TiS₂(D(v, 50%) = 100 nm) | 3.5 × 10⁻⁶ |
| PEO₁₀—LiN(SO₂CF₃)₂—TiS₂(D(v, 50%) = 10 nm) | 5.1 × 10⁻⁵ |

As shown in Table 14, the addition of TiS₂ increases ionic conductivity, and such an increase in ionic conductivity is improved as the particle size of TiS₂ becomes smaller. This is believed to be because an inorganic additive such as TiS₂ prevents crystallization of the polymer.

The increases in ionic conductivity according to the amount of TiS₂ were measured. TiS₂ with a particle size D (v, 50%) of 10 nm was used. The results are presented in Table 15.

TABLE 15

| | Ionic conductivity (S/cm) |
|---|---|
| Type of polymer film | (room temperature) |
| HPEO₁₀—LiN(SO₂CF₃)₂—TiS₂(2 wt %) | 1.2 × 10⁻⁶ |
| PEO₁₀—LiN(SO₂CF₃)₂—TiS₂(5 wt %) | 4.4 × 10⁻⁶ |
| PEO₁₀—LiN(SO₂CF₃)₂—TiS₂(10 wt %) | 5.1 × 10⁻⁶ |
| PEO₁₀—LiN(SO₂CF₃)₂—TiS₂(15 wt %) | 3.2 × 10⁻⁶ |
| PEO₁₀—LiN(SO₂CF₃)₂—TiS₂(20 wt %) | 2.2 × 10⁻⁶ |
| PEO₁₀—LiN(SO₂CF₃)₂—TiS₂(25 wt %) | 8.6 × 10⁻⁶ |

It is evident from Table 15 that an amount of 5 to 15 wt % of TiS₂ exhibited higher ionic conductivity.

These two test results indicate that TiS₂ increases ionic conductivity, and as the particle size of TiS₂ decreases, ionic conductivity increases.

<Experiment 12: Measurement of Surface Roughness>

The surface roughness Ra of each positive electrode according to Examples 22 to 27 and Comparative Example 1 were measured, and the results are shown in Table 16.

TABLE 16

| | Composition of the positive | Surface |
|---|---|---|
| | electrode (weight ratio) | roughness (Ra) |
| Comparative | Sulfur/Conductive material/Binder | 3.0 |
| Example 1 | (6/2/2) | |
| Example 22 | Sulfur/Conductive material/Binder/ | 7.6 |
| | TiS₂(A:D(v, 50%) = 75,000 nm) | |
| | (6/2/2/1) | |
| Example 23 | Sulfur/Conductive material/Binder/ | 5.4 |
| | TiS₂(A:D(v, 50%) = 20,000 nm) | |
| | (6/2/2/1) | |
| Example 24 | Sulfur/Conductive material/Binder/ | 3.0 |
| | TiS₂(A:D(v, 50%) = 5,000 nm) | |
| | (6/2/2/1) | |
| Example 25 | Sulfur/Conductive material/Binder/ | 2.6 |
| | TiS₂(A:D(v, 50%) = 1,000 nm) | |
| | (6/2/2/1) | |
| Example 26 | Sulfur/Conductive material/Binder/ | 2.4 |
| | TiS₂(A:D(v, 50%) = 100 nm) | |
| | (6/2/2/1) | |
| Example 27 | Sulfur/Conductive material/Binder/ | 2.3 |
| | TiS₂(A:D(v, 50%) = 10 nm) | |
| | (6/2/2/1) | |

In Table 16, Ra indicates the arithmetic mean of each peak (between highest and lowest peaks), and the lower Ra indicates a more uniform surface. It is evident from Table 16 that Examples 24 to 27 exhibited improved surface roughness.

<Experiment 13: Measurement of Battery Performance>

Using positive electrodes according to each of Examples 22 to 27 and Comparative Example 1, pouch-type lithium-sulfur cells were fabricated by the following procedure. The size of each positive electrode was 25 mm×50 mm. The cells were test cells with a higher capacity than a coin cell (capacity of 3-5 mAh).

A tab was welded to each positive electrode, and the resulting positive electrode was placed in a pouch. On the positive electrode, a separator was positioned. A tab-attached lithium foil was placed on the separator, and the pouch was sealed except for an electrolyte inserting hole. 1M LiN(SO₂CF₃)₂ in dimethoxyethane/1,3-dioxolane (80/20 volume ratio) was injected into the pouch.

The cells were charged at 0.2C and discharged at 0:5C, the 1^{st} capacity and cycle life for 100^{th} cycles were measured, and the results are presented in Table 17. In addition, internal resistance of the batteries and surface roughness Ra of the positive electrodes are shown in Table 17.

TABLE 17

| | | | | Cycle life |
|---|---|---|---|---|
| | Surface | Internal | 1^{st} capacity | for 100th |
| | roughness (Ra) | resistance (Ω) | (mAh/g) | cycles (%) |
| Comparative | 3.0 | 9.8 | 1200 | 60 |
| Example 1 | | | | |
| Example 22 | 7.6 | 12.3 | 1175 | 63 |
| Example 23 | 5.4 | 10.5 | 1185 | 74 |
| Example 24 | 3.0 | 9.8 | 1211 | 73 |
| Example 25 | 2.6 | 9.5 | 1246 | 83 |
| Example 26 | 2.4 | 9.6 | 1254 | 88 |
| Example 27 | 2.3 | 9.4 | 1279 | 90 |

It is shown in Table 17 that Examples 22 to 27 using TiS₂ exhibited lower surface roughness than Comparative Example 1 without TiS₂. Such a lower surface roughness renders a decrease in interfacial resistance, causing a decrease in internal resistance of the battery and an increase in 1^{st} capacity and cycle life.

### EXAMPLES 28 to 32

### Test for Battery Performance According to Amount of Added TiS₂

Positive electrodes for a lithium-sulfur cell were produced by the same procedure as in Example 22, except that amounts of TiS₂ with a particle size D (v, 50%) of 10 nm were varied as set forth in the following Table 18. The surface roughness of each positive electrode was measured, and the results are shown in Table 18. The result according to Example 27 with a particle size D (v, 50%) of 10 nm is also shown in Table 18.

TABLE 18

| | Composition of positive | Surface |
|---|---|---|
| | electrode (weight ratio) | roughness (Ra) |
| Comparative | Sulfur/Conductive material/ | 3.0 |
| Example 1 | Binder (60/20/20) | |
| Example 28 | Sulfur/Conductive material/Binder/ | 2.9 |
| | TiS₂(A:D(v, 50%) = 10 nm) | |
| | (60/20/20/2) | |
| Example 29 | Sulfur/Conductive material/Binder/ | 2.7 |
| | TiS₂(A:D(v, 50%) = 10 nm) | |
| | (60/20/20/5) | |
| Example 27 | Sulfur/Conductive material/Binder/ | 2.3 |
| | TiS₂(A:D(v, 50%) = 10 nm) | |
| | (60/20/20/10) | |
| Example 30 | Sulfur/Conductive material/Binder/ | 2.2 |
| | TiS₂(A:D(v, 50%) = 10 nm) | |
| | (60/20/20/15) | |
| Example 31 | Sulfur/Conductive material/Binder/ | 2.3 |
| | TiS₂(A:D(v, 50%) = 10 nm) | |
| | (60/20/20/20) | |
| Example 32 | Sulfur/Conductive material/Binder/ | 2.2 |
| | TiS₂(A:D(v, 50%) = 10 nm) | |
| | (60/20/20/25) | |

Table 18 indicates that a particle size of TiS₂ less than or equal to that of the positive active material decreases surface roughness when compared with Comparative Example 1 without TiS₂.

<Experiment 14: Measurement of Battery Performance>

Using positive electrodes according to each of Examples 27 to 32, pouch-type lithium sulfur cells were fabricated by the same procedure as in Experiment 13. The cells were charged at 0.2C and discharged at 0.5C, the 1^{st} capacity and cycle life for 100^{th} cycles were measured, and the results are presented in Table 19. In addition, internal resistance of each battery and surface roughness Ra of each positive electrode are shown in Table 19.

TABLE 19

| | | | | Cycle life |
|---|---|---|---|---|
| | Surface | Internal | 1^{st} capacity | for 100^{th} |
| | roughness (Ra) | resistance (Ω) | (mAh/g) | cycles (%) |
| Comparative | 3.0 | 9.8 | 1200 | 60 |
| Example 1 | | | | |
| Example 28 | 2.9 | 9.7 | 1228 | 70 |
| Example 29 | 2.7 | 9.6 | 1244 | 85 |
| Example 27 | 2.3 | 9.4 | 1279 | 90 |
| Example 30 | 2.2 | 9.3 | 1250 | 88 |
| Example 31 | 2.3 | 9.4 | 1237 | 82 |
| Example 32 | 2.2 | 9.3 | 1229 | 72 |

It is shown in Table 19 that Examples 27 to 31 using TiS₂ exhibited lower surface roughness than Comparative Example 1 without TiS₂. Such a lower surface roughness renders a decrease in interfacial resistance between the positive electrode and the separator, causing a decrease in internal resistance of the battery. As a result, the 1^{st} capacities in Examples 16 to 21 are slightly larger than that of Comparative Example 1, and the cycle life greatly increased by 5 to 20% when compared with Comparative Example 1. This result is believed to come about because of the higher ionic conductivity with 5 to 20 wt % of TiS₂, even though Examples 27 to 32 have similar surface roughness (See Table 15).

As a result, the TiS₂ additive with the critical particle size increases ionic conductivity of the positive electrode and decreases surface roughness, thereby increasing capacity from 1200 mAh to 1279 mAh, and improving cycle life from 60% to 90%.

### EXAMPLE 33

Al₂O₃ powder was pulverized in an isopropyl alcohol solvent with a zirconia ball for 1 hour, and the resulting material was dried at 80° C. to prepare an Al₂O₃ additive with a particle size D (v, 50%) of 35,000 nm.

The Al₂O₃ additive, an elemental sulfur (S₈) positive active material, a carbon conductive material, and a polyethyleneoxide binder were mixed in an acetonitrile solvent in the weight ratio of 1:6:2:2 with a ball to prepare a positive active material slurry. The elemental sulfur (S₈) was obtained from pulverization with a zirconia ball in isopropylalcohol solvent, and drying, and it had a particle size D (v, 50%) of 5,000 nm.

The positive active material slurry was coated on a carbon-coated Al current collector to produce a positive electrode for a lithium-sulfur battery.

### EXAMPLE 34

A positive electrode was produced by the same procedure as in Example 33, except that the pulverization step was performed for 3 hours to prepare an Al₂O₃ additive with a particle size D (v, 50%) of 5,000 nm.

### EXAMPLE 35

A positive electrode was produced by the same procedure as in Example 33, except that the pulverization step was performed for 6 hours to prepare an Al₂O₃ additive with a particle size D (v, 50%) of 200 nm.

### EXAMPLE 36

A positive electrode was produced by the same procedure as in Example 33, except that the pulverization step was performed for 12 hours to prepare an Al₂O₃ additive with a particle size D (v, 50%) of 50 nm.

### EXAMPLE 37

A positive electrode was produced by the same procedure as in Example 33, except that the pulverization step was performed for 24 hours to prepare an Al₂O₃ additive with a particle size D (v, 50%) of 6 nm.

### EXAMPLE 38

A positive electrode was produced by the same procedure as in Example 33, except that the pulverization step was performed for 48 hours to prepare an Al₂O₃ additive with a particle size D (v, 50%) of 5.8 nm.

### EXAMPLE 39

A positive electrode was produced by the same procedure as in Example 33, except that a V₂O₅ additive with a particle size D (v, 50%) of 109,000 nm without a pulverization step was used.

<Experiment 1: Measurement of Ionic Conductivity According to a Particle size D (v, 50%) of Al₂O₃>

Polyethylene oxide with a molecular weight of 5,000,000 was dissolved in acetonitrile, and a LiN(SO₂CF₃)₂ lithium salt was added thereto and dissolved therein until the mole ratio of ethylene oxide to Li reached 10:1. An Al₂O₃ additive according to one of Examples 33 to 39 and Comparative Example 1 was added to the resulting solution in the amount of 10 wt % of the total amount of polyethylene oxide and the LiN(SO₂CF₃)₂ lithium salt, and they were shaken for 2 hours. The resulting solution was cast to form a polymer film, and the ionic conductivity thereof was measured. The results are presented in Table 20.

TABLE 20

| | Ionic conductivity (S/cm) |
|---|---|
| Type of polymer film | (room temperature) |
| PEO₁₀—LiN(SO₂CF₃)₂ | 9.6 × 10⁻⁷ |
| PEO₁₀—LiN(SO₂CF₃)₂—Al₂O₃(D(v, 50%) = | 1.5 × 10⁻⁶ |
| 109,000 nm) | |
| PEO₁₀—LiN(SO₂CF₃)₂—Al₂O₃(D(v, 50%) = | 2.7 × 10⁻⁶ |
| 35,000 nm) | |
| PEO₁₀—LiN(SO₂CF₃)2—Al₂O₃(D(v, 50%) = | 3.7 × 10⁻⁶ |
| 5,000 nm) | |
| PEO₁₀—LiN(SO₂CF₃)₂—Al₂O₃(D(v, 50%) = | 7.6 × 10⁻⁶ |
| 200 nm) | |
| PEO₁₀—LiN(SO₂CF₃)₂—Al₂O₃(D(v, 50%) = | 4.2 × 10⁻⁵ |
| 50 nm) | |
| PEO₁₀—LiN(SO₂CF₃)₂—Al₂O₃(D(v, 50%) = | 5.0 × 10⁻⁵ |
| 6 nm) | |

As shown in Table 20, the addition of Al₂O₃ increases ionic conductivity, and such an increase in ionic conductivity is improved as the particle size of Al₂O₃ decreases. This is believed to be because the inorganic additive such as Al₂O₃ prevents the crystallization of the polymer.

The increases in ionic conductivity according to the amount of Al₂O₃ were measured. Al₂O₃ with a particle size D (v, 50%) of 6 nm was used. The results are presented in Table 21.

TABLE 21

| | Ionic conductivity |
|---|---|
| Type of polymer film | (S/cm)(room temperature) |
| PEO₁₀—LiN(SO₂CF₃)₂—Al₂O₃ (2 wt %) | 1.2 × 10⁻⁵ |
| PEO₁₀—LiN(SO₂CF₃)₂—Al₂O₃ (5 wt %) | 4.1 × 10⁻⁵ |
| PEO₁₀—LiN(SO₂CF₃)₂—Al₂O₃ (10 wt %) | 5.0 × 10⁻⁵ |
| PEO₁₀—LiN(SO₂CF₃)₂—Al₂O₃ (15 wt %) | 3.8 × 10⁻⁵ |
| PEO₁₀—LiN(SO₂CF₃)₂—Al₂O₃ (20 wt %) | 2.2 × 10⁻⁵ |
| PEO₁₀—LiN(SO₂CF₃)₂—Al₂O₃ (25 wt %) | 7.0 × 10⁻⁶ |

It is evident from Table 21 that an amount of 5 to 15 wt % of Al₂O₃ exhibited higher ionic conductivity.

These two test results indicate that Al₂O₃ increases ionic conductivity and as the particle size of Al₂O₃ decreases, ionic conductivity increases.

<Experiment 16: Measurement of Surface Roughness>

The surface roughness Ra of each positive electrode according to Examples 33 to 39 and Comparative Example 1 was measured, and the results are shown in Table 22.

TABLE 22

| | | Surface |
|---|---|---|
| | Composition of the positive electrode (weight ratio) | roughness (Ra) |
| Comparative | Sulfur/Conductive material/Binder (6/2/2) | 3.0 |
| Example 1 | | |
| Example 39 | Sulfur/Conductive material/Binder/Al₂O₃(D(v, 50%) = 109,000 nm) | 11.5 |
| | (6/2/2/1) | |
| Example 33 | Sulfur/Conductive material/Binder/Al₂O₃(D(v, 50%) = 35,000 nm) | 6.2 |
| | (6/2/2/1) | |
| Example 34 | Sulfur/Conductive material/Binder/Al₂O₃(D(v, 50%) = 5,000 nm) | 3.0 |
| | (6/2/2/1) | |
| Example 35 | Sulfur/Conductive material/Binder/Al₂O₃(D(v, 50%) = 200 nm) | 2.8 |
| | (6/2/2/1) | |
| Example 36 | Sulfur/Conductive material/Binder/Al₂O₃(D(v, 50%) = 50 nm) | 2.6 |
| | (6/2/2/1) | |
| Example 37 | Sulfur/Conductive material/Binder/Al₂O₃(D(v, 50%) = 6 nm) | 2.3 |
| | (6/2/2/1) | |

In Table 22, Ra indicates the arithmetic mean of each peak (between highest and lowest peaks), and the lower Ra indicates a more uniform surface. It is evident from Table 22 that Examples 33 and 39 with a particle size of Al₂O₃ larger than the sulfur active material (5,000 nm) exhibited poorer uniformity (unevenness and roughness) than Comparative Example 1 without Al₂O₃, and Examples 34 to 37 with a smaller or the same particle size of Al₂O₃ as the active material exhibited the same or better uniformity.

<Experiment 17: Measurement of Battery Performance>

Using positive electrodes according to each of Examples 33 to 39 and Comparative Example 1, pouch-type lithium-sulfur cells were fabricated by the following procedure. The size of each positive electrode was 25 mm×50 mm. The cells were test cells with a higher capacity than a coin cell (capacity of 3-5 mAh).

A tab was welded to each positive electrode, and the resulting positive electrode was placed in a pouch. On the positive electrode, a separator was positioned. A tab-attached lithium foil was placed on the separator, and the pouch was sealed except for an electrolyte inserting hole. 1M LiN(SO₂CF₃)₂ in dimethoxyethane/1,3-dioxolane (80/20 volume ratio) was injected into the pouch.

The cells were charged at 0.2C and discharged at 0.5C, and the 1^{st} capacity and cycle life for the 100^{th} cycles were measured, and the results are presented in Table 23. In addition, internal resistance of each battery and surface roughness Ra of each positive electrode are shown in Table 23.

TABLE 23

| | Surface | Internal | 1^{st} | Cycle life |
|---|---|---|---|---|
| | roughness | resistance | capacity | for 100th |
| | (Ra) | (Ω) | (mAh/g) | cycles (%) |
| Comparative | 3.0 | 9.8 | 1200 | 60 |
| Example 1 | | | | |
| Example 39 | 11.5 | 14.5 | 1188 | 62 |
| Example 33 | 6.2 | 11.5 | 1165 | 65 |
| Example 34 | 3.0 | 9.8 | 1210 | 75 |
| Example 35 | 2.8 | 9.5 | 1236 | 85 |
| Example 36 | 2.6 | 9.6 | 1254 | 89 |
| Example 37 | 2.3 | 9.4 | 1289 | 91 |

It is shown in Table 23 that Examples 34 to 38 using Al₂O₃ with the same or smaller particle size than the sulfur positive active material (5,000 nm) exhibited lower surface roughness than Comparative Example 1 without Al₂O₃. Such a lower surface roughness renders a decrease in interfacial resistance, causing a decrease in internal resistance of the battery and an increase in 1^{st} capacity and cycle life.

On the other hand, Examples 33 and 39 using Al₂O₃ with a particle size larger than the sulfur positive active material (5,000 nm) exhibited more surface roughness, which results in an increase in internal resistance and a decrease in capacity and cycle life.

### EXAMPLES 38 to 42

### Test for Battery Performance According to Amount of added V₂O₅

Positive electrodes were produced by the same procedure as in Example 33, except that amounts of Al₂O₃ with a particle size D (v, 50%) of 6 nm were varied as set forth in the following Table 24. The surface roughness of each positive electrode was measured, and the results are shown in Table 24. The result according to Example 36 with a particle size D (v, 50%) of 6 nm is also shown in Table 24.

TABLE 24

| | | Surface |
|---|---|---|
| | | roughness |
| | Composition of positive electrode (weight ratio) | (Ra) |
| Comparative | Sulfur/Conductive material/Binder (60/20/20) | 3.0 |
| Example 1 | | |
| Example 38 | Sulfur/Conductive material/Binder/Al₂O₃(A: D(v, 50%) = 6 nm) | 2.8 |
| | (60/20/20/2) | |
| Example 39 | Sulfur/Conductive material/Binder/Al₂O₃(A: D(v, 50%) = 6 nm) | 2.8 |
| | (60/20/20/5) | |
| Example 36 | Sulfur/Conductive material/Binder/Al₂O₃(A: D(v, 50%) = 6 nm) | 2.3 |
| | (60/20/20/10) | |
| Example 40 | Sulfur/Conductive material/Binder/Al₂O₃(A: D(v, 50%) = 6 nm) | 2.2 |
| | (60/20/20/15) | |
| Example 41 | Sulfur/Conductive material/Binder/Al₂O₃(A: D(v, 50%) = 6 nm) | 2.4 |
| | (60/20/20/20) | |
| Example 42 | Sulfur/Conductive material/Binder/Al₂O₃(A: D(v, 50%) = 6 nm) | 2.3 |
| | (60/20/20/25) | |

Table 24 indicates that the same or smaller particle size of Al₂O₃ than the positive active material decreases surface roughness when compared with Comparative Example 1 without Al₂O₃.

<Experiment 18: Measurement of Battery Performance>

Using positive electrode according to each of Examples 36 and 38 to 42, pouch-type lithium sulfur cells were fabricated by the same procedure as in Experiment 17. The cells were charged at 0.2C and discharged at 0.5C, the 1^{st} capacity and cycle life for 100^{th} cycles were measured, and the results are presented in Table 25. In addition, internal resistance of each battery and surface roughness Ra of each positive electrode are shown in Table 25.

TABLE 25

| | Surface | Internal | 1^{st} | Cycle life for |
|---|---|---|---|---|
| | roughness | resistance | capacity | 100^{th} |
| | (Ra) | (Ω) | (mAh/g) | cycles (%) |
| Comparative | 3.0 | 9.8 | 1200 | 60 |
| Example 1 | | | | |
| Example 38 | 2.8 | 9.6 | 1218 | 71 |
| Example 39 | 2.8 | 9.6 | 1240 | 87 |
| Example 36 | 2.3 | 9.4 | 1289 | 91 |
| Example 40 | 2.2 | 9.3 | 1255 | 88 |
| Example 41 | 2.4 | 9.5 | 1239 | 86 |
| Example 42 | 2.3 | 9.4 | 1231 | 75 |

It is shown in Table 25 that Examples 36 and 38 to 42 using Al₂O₃ with the same or smaller particle size than the sulfur positive active material (5,000 nm) exhibited lower surface roughness than Comparative Example 1 without Al₂O₃. Such a lower surface roughness renders a decrease in interfacial resistance, causing a decrease in internal resistance of the battery. As a result, the 1^{st} capacities in Examples 36 and 38 to 42 are slightly larger than that in Comparative Example 1, and the cycle life greatly increases by 5 to 20% when compared to Comparative Example 1. This result is believed to come about from higher ionic conductivity in 5 to 20 wt % of Al₂O₃ even though Examples 36 and 38 to 42 have similar surface roughness (See Table 21).

As a result, the Al₂O₃ additive with the critical particle size increases ionic conductivity of the positive electrode and decreases surface roughness, thereby increasing capacity from 1200 mAh to 1289 mAh, and improving cycle life from 60% to 91%.

While the present invention has been described in detail with reference to the preferred embodiments, those skilled in the art will appreciate that various modifications and substitutions can be made thereto without departing from the spirit and scope of the present invention as set forth in the appended claims.

What is claimed is:

1. A positive electrode for a lithium-sulfur battery comprising:
a positive active material selected from the group consisting of elemental sulfur (S₈), a sulfur-based compound, and mixtures thereof;
a conductive material;
a binder; and
an inorganic additive with a particle size D (v, 50%) of 5,000 nm or less and that is insoluble in an electrolyte comprising a non-aqueous organic solvent.

2. The positive electrode of claim 1, wherein the inorganic additive is selected from the group consisting of metal oxides, metal sulfides, and mixturesthereof.

3. The positive electrode of claim 2, wherein the metal is at least one selected from the group consisting of V, Al, Zr, and Ti.

4. The positive electrode of claim 1, wherein the inorganic additive is at least one selected from the group consisting of V₂O₅, ZrO₂, and TiS₂.

5. The positive electrode of claim 1, wherein the inorganic additive has a particle size D (v, 50%) of 1 to 5,000 nm.

6. The positive electrode of claim 5, wherein the inorganic additive has a particle size D (v, 50%) of 5 to 4,000 nm.

7. The positive electrode of claim 6, wherein the inorganic additive has a particle size D (v, 50%) of 10 to 3,000 nm.

8. The positive electrode of claim 1, wherein the inorganic additive is present in an amount of 1 to 50 wt %.

9. The positive electrode of claim 1, wherein the inorganic additive is present in an amount of 2 to 25 wt %.

10. The positive electrode of claim 1, wherein the inorganic additive is present in an amount of 3 to 20 wt %.

11. The positive electrode of claim 1, wherein the sulfur-based compound is selected from the group consisting of Li₂Sₙ, wherein n≧1,) organic-sulfur compounds, and carbon-sulfur polymers having the formula (C₂Sₓ)ₙ, where x=2.5 to 50 and n>2.

12. The positive electrode of claim 1, wherein the positive electrode further comprises a coating layer, the coating layer comprising a polymer, an inorganic material, or a mixture thereof.

13. The positive electrode of claim 12, wherein the coating layer comprises a polymer selected from the group consisting of polyvinylidene fluoride, copolymers of polyvinylidene fluoride and hexafluoropropylene, poly(vinyl acetate), poly(vinyl butyral-co-vinyl alcohol-co-vinyl acetate), poly(methylmethacrylate-co-ethyl acrylate), polyacrylonitrile, polyvinyl chloride-co-vinyl acetate, polyvinyl alcohol, poly(1-vinylpyrrolidone-co-vinyl acetate), cellulose acetate, polyvinyl pyrrolidone, polyacrylate, polymethacrylate, polyolefin, polyurethane, polyvinyl ether, acrylonitrile-butadiene rubber, styrene-butadiene rubber, acrylonitrile-butadiene styrene, a sulfonated styrene/ethylene-butylene/styrene triblock copolymer, polyethylene oxide, and mixtures thereof.

14. The positive electrode of claim 12, wherein the coating layer comprises an inorganic material selected from the group consisting of colloidal silica, amorphous silica, surface-treated silica, colloidal alumina, amorphous alumina, tin oxide, titanium oxide, vanadium oxide, titanium oxide (TiS₂), zirconium oxide (ZrO₂), iron oxide, iron sulfide (FeS), iron titanate (FeTiO₃), barium titanate (BaTiO₃), and mixtures thereof.

15. The positive electrode of claim 12, wherein the coating layer comprises conductive carbon.

16. A positive electrode for a lithium-sulfur battery comprising:
a positive active material selected from the group consisting of elemental sulfur (S₈), sulfur-based compounds, and mixtures thereof;
a conductive material;
a binder; and
an inorganic additive comprising one or more metal oxides or metal sulfides.

17. The positive electrode of claim 16, wherein the metal is at least one selected from the group consisting of V, Al, Zr, and Ti.

18. The positive electrode of claim 16, wherein the inorganic additive is Al₂O₃.

19. The positive electrode of claim 16, wherein the inorganic additive has a particle size D (v, 50%) of 35,000 nm or less.

20. The positive electrode of claim 19, wherein the inorganic additive has a particle size D (v, 50%) of 1 to 35,000 nm.

21. The positive electrode of claim 20, wherein the inorganic additive has a particle size D (v, 50%) of 3 to 10,000 nm.

22. The positive electrode of claim 21, wherein the inorganic additive has a particle size D (v, 50%) of 5 to 5,000 nm.

23. The positive electrode of claim 16, wherein the inorganic additive is present in an amount of 1 to 50 wt %.

24. The positive electrode of claim 23, wherein the inorganic additive is present in an amount of 2 to 25 wt %.

25. The positive electrode of claim 24, wherein the inorganic additive is present in an amount of 3 to 20 wt %.

26. The positive electrode of claim 15, wherein the sulfur-based compound is selected from the group consisting of Li₂Sₙ, wherein n≧1, organic-sulfur compounds and carbon-sulfur polymers of the formula (C₂Sx), wherein x=2.5 to 50 and n≧2.

27. The positive electrode of claim 16, wherein the positive electrode further comprises a coating layer, the coating layer comprising a polymer, an inorganic material or a mixture thereof.

28. The positive electrode of claim 27, wherein the coating layer comprises a polymer selected from the group consisting of polyvinylidene fluoride, copolymers of polyvinylidene fluoride and hexafluoropropylene, poly(vinyl acetate), poly(vinyl butyral-co-vinyl alcohol-co-vinyl acetate), poly(methylmethacrylate-co-ethyl acrylate), polyacrylonitrile, polyvinyl chloride-co-vinyl acetate, polyvinyl alcohol, poly(1-vinylpyrrolidone-co-vinyl acetate), cellulose acetate, polyvinyl pyrrolidone, polyacrylate, polymethacrylate, polyolefin, polyurethane, polyvinyl ether, acrylonitrile-butadiene rubber, styrene-butadiene rubber, acrylonitrile-butadiene styrene, a sulfonated styrene/ethylene-butylene/styrene triblock copolymer, polyethylene oxide, and mixtures thereof.

29. The positive electrode of claim 27, wherein the coating layer comprises an inorganic material selected from the group consisting of colloidal silica, amorphous silica, surface-treated silica, colloidal alumina, amorphous alumina, tin oxide, titanium oxide, vanadium oxide, titanium oxide (TiS₂), zirconium oxide (ZrO₂), iron oxide, iron sulfide (FeS), iron titanate (FeTiO₃), barium titanate (BaTiO₃), and mixtures thereof.

30. The positive electrode of claim 27, wherein the coating layer comprises conductive carbon.
